(19) United States
(12) Patent Application Publication
(10) Pub. No.: US 2018/0121545 A1
(43) Pub. Date: May 3, 2018

(54) METHODS AND SYSTEM FOR IMPROVING THE RELEVANCE, USEFULNESS, AND EFFICIENCY OF SEARCH ENGINE TECHNOLOGY

(71) Applicants: Mei Chen, Mont-Royal (CA); Michel Decary, Mont-Royal (CA)

(72) Inventors: Mei Chen, Mont-Royal (CA); Michel Decary, Mont-Royal (CA)

(73) Assignee: Cogilex R&D inc., Mont-Royal (CA)

(21) Appl. No.: 15/706,733

(22) Filed: Sep. 17, 2017

Related U.S. Application Data
(60) Provisional application No. 62/396,145, filed on Sep. 17, 2016.

(51) Int. Cl. G06F 17/30; G06F 17/27; G06F 15/18

(52) U.S. Cl. CPC G06F 17/30864; G06F 17/2785; G06F 15/18; G06F 17/30613; G06F 17/30684

(57) ABSTRACT

The disclosed methods, systems, and apparatus use Natural Language Processing (NLP) in conjunction with a world model and cognitive frames to semantically analyze, understand, rank, store, and retrieve digital text. The goal is to improve the relevance, usefulness and efficiency of information search. The world model represents things existing in the real world whereas cognitive frames specify possible user interaction with such a world. Using NLP in conjunction with a world model and cognitive frames to understand text is an advancement in automated text analysis. It addresses three serious shortcomings of the existing search technology: the inadequate measure of the meaningful content in web pages; a poor understanding of users' goals and tasks in their search and, the irrelevant search results. The disclosed methods have led to the successful implementation of a full-scale semantic search engine in medicine, and they are applicable and adaptable to other disciplines.

### TECHNICAL FIELD

The invention relates to search engine technology, automated text analysis, natural language processing, automated text understanding, semantic extraction of information, computer systems utilizing knowledge based models, knowledge representation (e.g., knowledge engineering, extracting information from data, frames). In particular, invention relates to methods, system, apparatus for analyzing, understanding, ranking, indexing, storing, retrieving, extracting, and displaying computer readable text using natural language processing (NLP) in conjunction with a world model that mimics things in the real world and a cognitive frame that characterizes users' interaction with this world.

### BACKGROUND OF THE INVENTION

The methods and system are aimed at addressing three serious shortcomings of the existing search technology: (a) a lack of a reasonable measure of what constitutes real meaningful content in web pages. Current search engines use URL and keyword frequency as the primary measure of relevance without considering the meaning of text, which often produces masses of unfocused results, (b) a lack of an adequate representation of the world and things in it, which results in a poor understanding of what users are searching, producing superficial lexical retrieval, (c) a lack of adequate understanding of users' goal, tasks, and activities in relation to the world in which they function, which further contributes to the retrieval of irrelevant content.

Studies have shown that most people now use the Internet as their primary source for all-purpose information search (PEW Research Center, 2017), however, finding high-quality and relevant information on things important to people (e.g., health or medical related information) remains a challenging task (Fiksdal et al, 2014, Pinchin, 2016). It is reported that most users don't go beyond the first page of the search results; Information overload, irrelevant and repetitive content, the feeling of being lost, and exhaustion were cited as main reasons for terminating search early (Fiksdal et al, 2014). Many researchers in the field of search engine technology have addressed the problem of large sets of irrelevant and unreliable search results provided by traditional search engines (Remi & Varghese, 2015). Such problems indicate that existing search engines are inadequate for providing relevant and useful information that users often seek, and in the way that can effectively help them. Thus, there is a need to develop new methods and system that can improve the relevance, usefulness, and efficiency of information search.

To improve search engine technology, the method disclosed relies on natural language processing (NLP) in conjunction with a world model and a cognitive frame to analyze, understand, rank, select, index, store, retrieve, and extract textual information. This is an entirely new approach to search engine technology. Semantic approach to automated text analysis is not new, however, using NLP in conjunction with a world model that adequately represents things important in a task domain and cognitive frames that characterize people's interaction with the world is a true advancement in automated text understanding. This approach provides the frameworks for understanding the topics, situations, tasks, and processes in context therefore it becomes possible for understanding not only the meaning of text but also the goals of users and their information needs in such context. Understanding the intention and information needs of users has been one of the greatest challenges in search engine technology, the method disclosed in this patent is an advancement in this area.

Furthermore, in the field of semantic search technology, it has been a challenge to produce a full-scale, rule-based system that is of any practical significance. Most approaches in search engine technology and text mining are statistically based, and it is reported that certain search engines now have incorporated some elements of semantic search into their search algorithms in order to provide more relevant and useful search results (Efrati, 2012). So semantic search currently is used partially in a very limited context and workable solutions that provide adequate understanding of the text are yet to be developed. It is apparent that the semantic approaches that other people have taken so far are insufficient for producing functional, full-scale, rule-based semantic applications or systems that are capable to capture the deep content of web pages or text in general. A full-scale, rule-based semantical analysis system that can produce results of practical significance on important things matter in people lives (e.g., in the field of health or medicine) will be another advancement in search engine technology.

The methods and system disclosed in the patent have led to the successful implementation of a full-scale, rule-based, real-world semantic search engine in a complex domain of medicine, and they are applicable and adaptable to the semantic analysis of texts on other subject matters, or in other disciplines.

### SUMMARY OF THE INVENTION

The patent discloses methods, system, and apparatus that use Natural Language Processing (NLP) in conjunction with a world model and a cognitive frame to analyze, understand, rank, select, index, store, retrieve, or extract digital text. The goal is to improve the relevance, usefulness and efficiency of information search, particularly the search of unstructured text. The methods, system, and apparatus disclosed are described in terms of system architecture, mechanisms and processes.

### 1. System Architecture

The system architecture comprises the following components:

A world model: The world model mimics the real world and things in it. In the illustrative embodiment, a domain-specific micro world in medicine is defined within the macro world that that represents things existing in the real world.

One or more cognitive frame: A cognitive frame is the specification of users' interaction with the world, including things that users should know and do in such interaction. It also specifies the important aspects of a concept, procedure, task, or activity.

Semantic rules: Semantic rules are linguistic patterns that describe the meaningful aspects of entities, attributes, relations, actions, and interactions concerning a specific cognitive frame. Those semantic rules correspond to the linguistic elements in the text to be analyzed, as well as that in users' input.

A database containing the results of the semantic analysis: The system generates a database of sentences and pages associated with specific topics, cognitive frames, and semantic rules through the semantic analysis mechanism.

Guided exploratory interfaces that provide a comprehensive overview of the different types of information useful to users, and guide users in their information search.

### 2. The Mechanisms and Processes

The following mechanisms and processes are used by the system to analyze, understand, rank, select, index, store, retrieve, and extract the meaningful content of digital text:

Mechanism and processes for semantic analysis of the text: The system identifies the meaningful content of the text by applying semantic rules to the analysis of each sentence on a page. The system then indexes all sentences and pages by associating them with specific topics and cognitive frames and stores them in a database.

Mechanism and processes for ranking the relevance of pages: After applying semantic rules to the analysis of each sentence on a page, the system looks at each page as a whole to determine the nature of a page using multiple ranking algorithms and metrics. The goal is to identify what a page is about, and what is its relevance to the goals and tasks of potential users.

Mechanism and processes for matching user search queries to the text/pages in the database: The match of a search query comprises: analyzing the search query in terms of the goal and associated tasks of the intended users; Matching the search query with the text/web pages stored in the database using multiple ranking algorithms and metrics.

Mechanism and processes for constructing guided exploratory interfaces: The construction of guided exploratory interfaces comprises: computing a domain-specific cognitive frame related to the search query using text/web pages found in the database; Displaying search results from different sources in the order of their relevance to the topic and cognitive frame identified; displaying the specific relations that the topic has with entities in other object classes.

### BRIEF DESCRIPTION OF THE OF THE DRAWING

The figures, graphs, drawings, or screenshots presented are for the purpose of describing the illustrative embodiment only and are not intended to be limiting of the invention.

FIG. 1 is a graph depicting the system architecture using an illustrative embodiment of the components, structure, relations, and processes.

FIG. 2 is a graph depicting the mechanism for semantic analysis of computer readable text.

FIG. 3 is a flowchart depicting the process for semantic analysis.

FIG. 4 is a flowchart depicting the mechanism for matching a user query to the text analyzed and stored in the database.

FIG. 5a is a graph illustrating an analysis of the user's goal and situation concerning a specific search query.

FIG. 5b is a graph illustrating the mechanism and process of constructing a guided exploration interface.

FIG. 6 is an illustrative embodiment of the macro world

FIGS. 7-8 is an illustrative embodiment of the micro world in medicine

FIG. 9 is an illustrative embodiment of the domain-specific cognitive frames in medicine

FIG. 10 is an illustrative embodiment of the domain-specific cognitive frame for disease

FIG. 11 is an illustrative embodiment of the domain-specific cognitive frame for drug

FIG. 12 is an illustrative embodiment of the domain-specific cognitive frame for medical procedure

FIGS. 13a-b is an illustrative embodiment of the domain-specific cognitive frame for understanding clinical research

FIG. 14 is a screenshot showing an illustrative example of a guided-exploratory interface design for disease

FIG. 15 is a screenshot showing an illustrative example of a guided-exploratory interface design for medical procedure

FIG. 16 is a screenshot showing an illustrative example of a guided-exploratory interface design for drug

### DESCRIPTION OF THE INVENTION

The present disclosure is to be considered as an exemplification of the invention, and is not intended to limit the invention to the specific embodiments illustrated by the figures or descriptions below.

The terminology used herein is for the purpose of describing particular embodiments only and is not intended to be limiting of the invention. It will be understood that the term “comprises” and/or “comprising,” when used in this specification, specify the presence of stated features, steps, operations, elements, and/or components, but do not preclude the presence or addition of one or more other features, steps, operations, elements, components, and/or groups thereof.

It will be understood that the term “frame”, “framework”, “model” or and/or “representation” when used in this specification, specify the presence of features, and/or components, but do not preclude the presence or addition of one or more other features, components, and/or groups thereof.

It will be understood that the term “digital text”, “digital content”, “computer readable text”, and/or “text” when used in this specification, specify any form of electronic textual information that is digital (e.g., text in web pages, textual description of videos, image labels, emails etc.), but do not preclude the presence or addition of one or more other form of computer readable text thereof.

The patent discloses methods, system, and apparatus that use Natural Language Processing in conjunction with a world model and a cognitive frame to analyze, understand, rank, select, index, store, retrieve, or extract digital text. The goal is to improve the relevance, usefulness and efficiency of information search, particularly the search of unstructured text. The methods, system, and apparatus disclosed are described in terms of system architecture, mechanisms and processes.

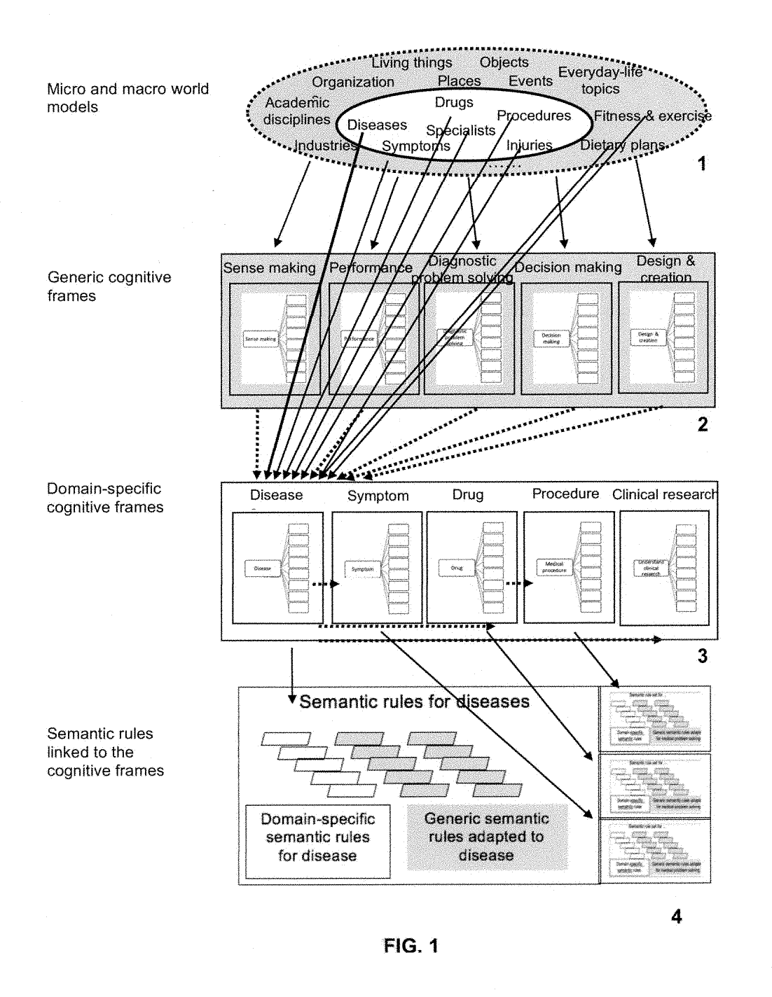

FIG. 1 is a graph depicting the system architecture using an illustrative embodiment of the components, structure, relations, and processes. The system architecture comprises the following components:

A world model: The world model mimics the real world and things in it. In the illustrative embodiment, a domain-specific micro world in medicine is defined within the macro world that represents things existing in the real world.

One or more cognitive frame: A cognitive frame is a characterization of users' interaction with the world, including things that users should know or do in such interaction. It also specifies the important aspects of a concept, procedure, task, or activity.

Semantic rules: Semantic rules are possible linguistic patterns that describe the meaningful aspects of entities, attributes, relations, actions, and interactions concerning a specific cognitive frame. These semantic rules correspond to the linguistic elements in the text to be analyzed, as well as that in users' input in any interactive system.

A database containing the results of the semantic analysis: The system generates a database of sentences and pages associated with specific topics, cognitive frames, and semantic rules through the semantic analysis mechanism.

Guided exploratory interfaces: They are generalized from the data stored to provide a comprehensive overview of the different types of information useful to users, and guide users in their information search.

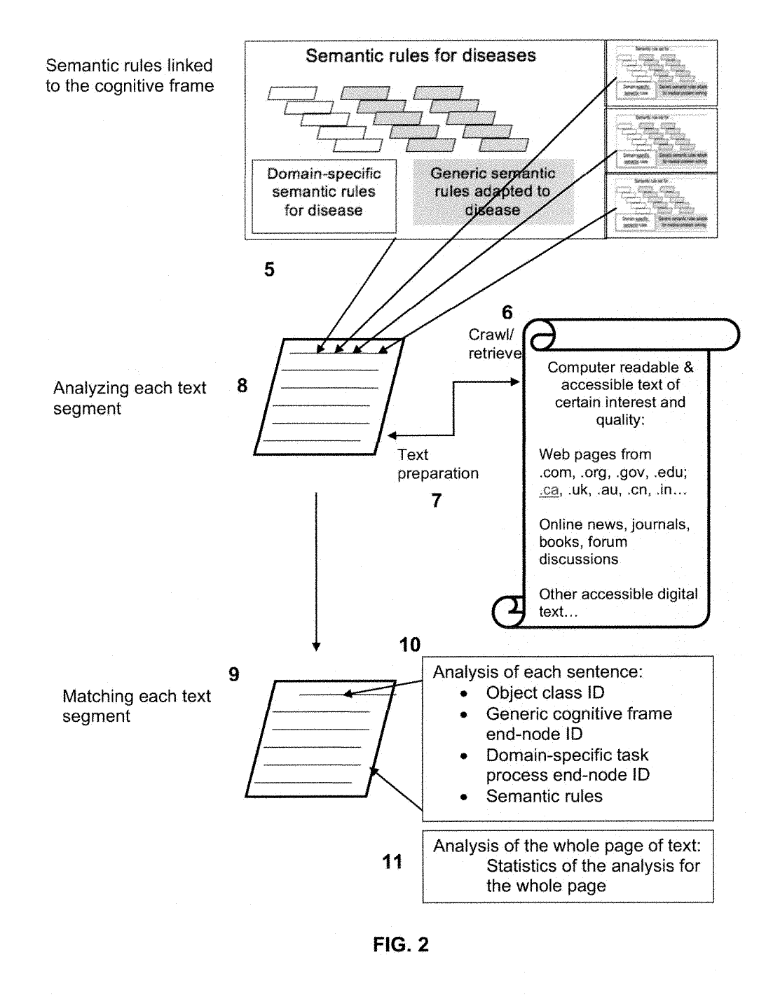

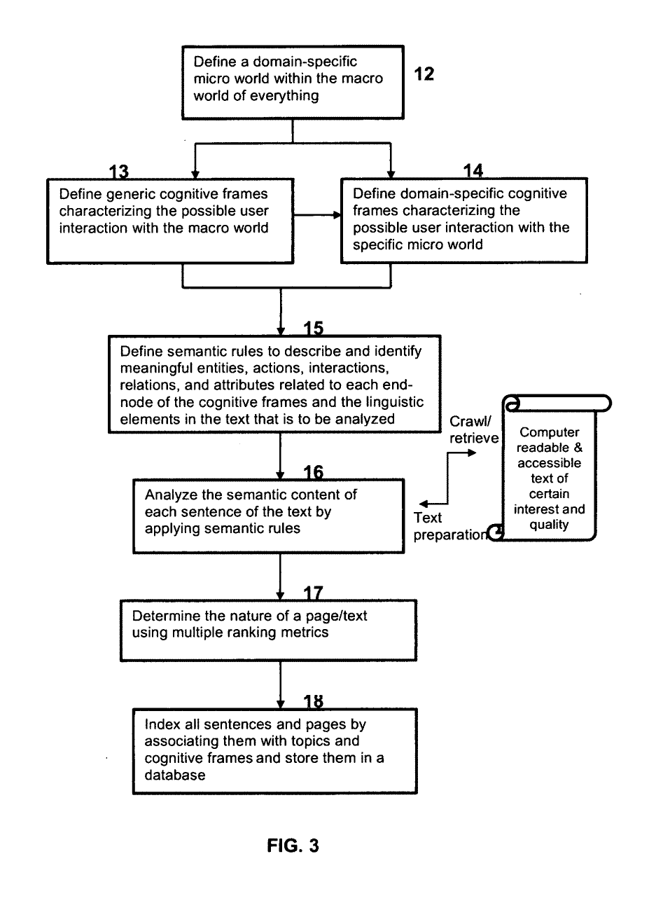

FIGS. 2-3 are graphs depicting the mechanism for semantic analysis of computer readable text. The following mechanisms and processes are used by the system to analyze, understand, rank, select, index, store retrieve, and extract the meaningful content of digital text:

Mechanism and processes for semantic analysis of the text: the system identifies the meaningful content of the text/web pages by applying semantic rules to the analysis of sentences on a page. The system then indexes all sentences and pages by associating them with specific topics and cognitive frames and stores them in a database.

Mechanism and processes for ranking the relevance of pages: After applying semantic rules to the analysis of each sentence on a page, the system looks at each page as a whole to determine the nature of a page using multiple ranking algorithms and metrics. The goal is to identify what a page is about, and what is its relevance to the goal, tasks, and information needs of potential users.

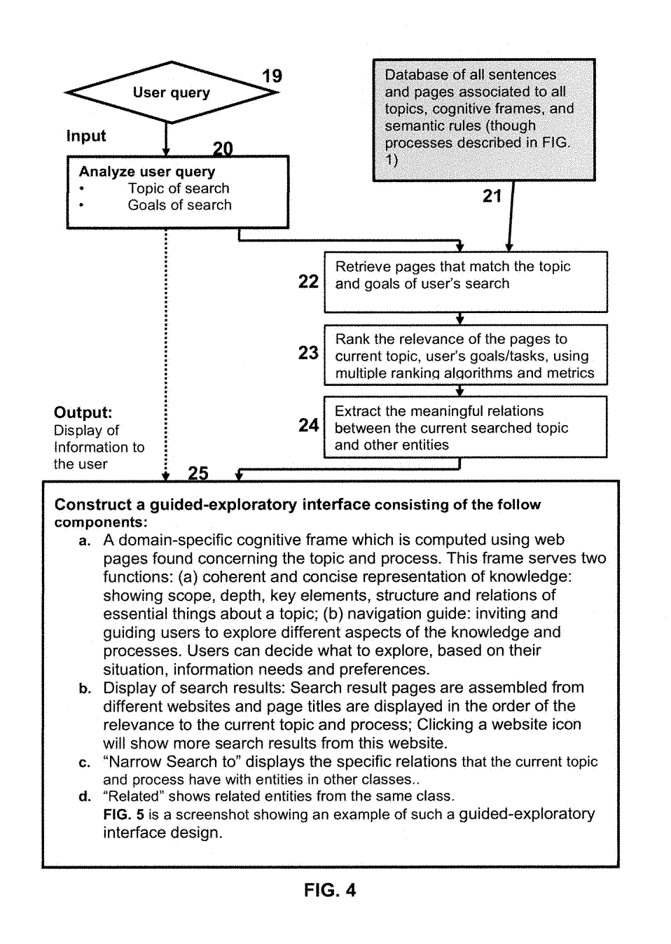

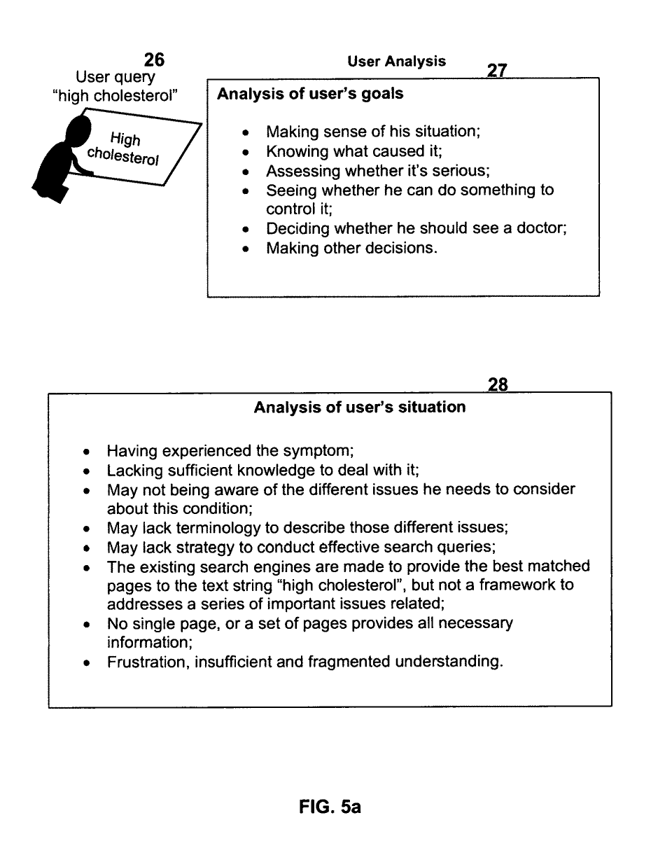

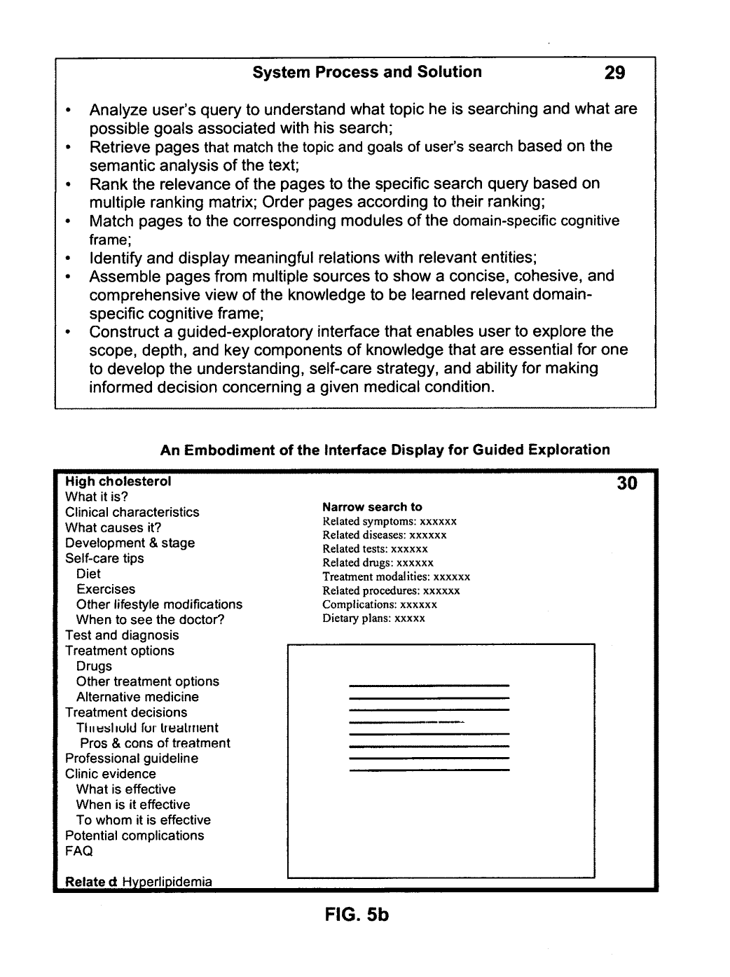

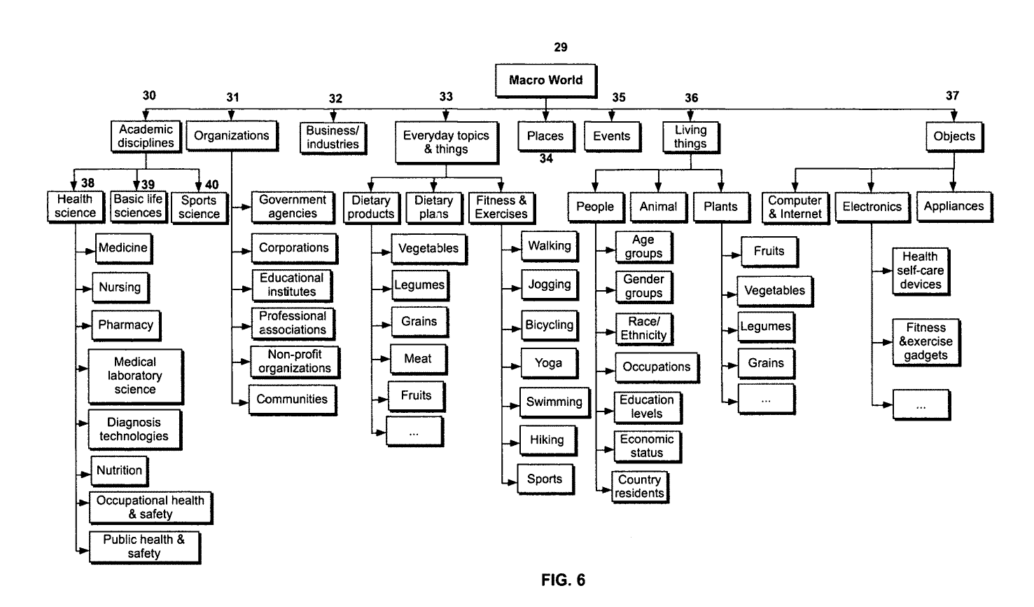

Mechanism and processes for matching user search queries to the text/pages in the database: FIGS. 4, 5a, and 5b depict the mechanism for matching a user query to the text analyzed and stored in the database. The match of a search query comprises: Analyzing the search query in terms of the goal and associated tasks of the intended users; Matching the search query with the text/web pages stored in the database using multiple ranking algorithms and metrics.

Mechanism and processes for constructing guided exploratory interfaces: FIGS. 5a, and 5b illustrates the analysis of user's goal and situation concerning a specific search query. The construction of guided exploratory interfaces comprises: computing a domain-specific cognitive frame related to the search query using text/web pages found in the database; Displaying search results from different sources in the order of their relevance to the topic and cognitive frame identified; displaying the specific relations that the topic has with other objects.

Below is the detailed description the system, methods, and processes of the invention:

### 1. System Architecture

### A World Model

The world model mimics the real world and things in it. In a preferred embodiment, a domain-specific micro world in medicine is defined within the macro world that represents things existing in the real world (FIG. 1). The representations of the world follow the convention and specification of object classes in terms of the structure, relationship, and properties. Such representations emphasize the structural relationship between different classes and their subclasses using hierarchical or tree structures such as ontologies and classifications (e.g., ontology of living things, subject classifications, the classification of diseases). In some cases, the representation can also be a flat list of things that share certain properties (a list of prevalent diseases, dietary plans or exercises). The key in developing the world model is that everything that matters is present, regardless whether it is general or domain-specific, and whether it is hierarchical or flat.

### Macro World

FIG. 6 shows a structured representation of the macro world. The macro world represents things existing in the real world, such as people, organizations, places, events, objects, activities (e.g., exercises, sports, sleep, smoke), and other things (e.g., dietary plans, food). The representation of the macro world is not mandatory but it is useful in order for the system to work at its best. The macro world should comprise object classes needed for understanding the meaning of general text to be analyzed. For understanding health- related content, some of the illustrative examples of things represented in the macro world are:
Academic disciplines
   Health sciences
      Medicine
      Nursing
      Medical laboratory science
      Diagnostic technology
      Pharmacy
      Nutrition
      Public health & safety
      Occupational health & safety
   Basic life sciences
   Sports science
   Environmental science
Business/industries
Organizations
Everyday topics & things
   Dietary plans
   Dietary products
   Fitness & Exercises
Living things
   People
      Age groups
      Gender groups
      Country residents
      Race/Ethnicity
      Occupations
      Education levels
      Economic status
   Animal
   Plants
      Fruits
      Vegetables
      Legumes
      Grains
Objects
   Computer & Internet
   Electronics
      Health self-care devices
      Fitness &exercise gadgets
Places
Events

### Micro Medical World

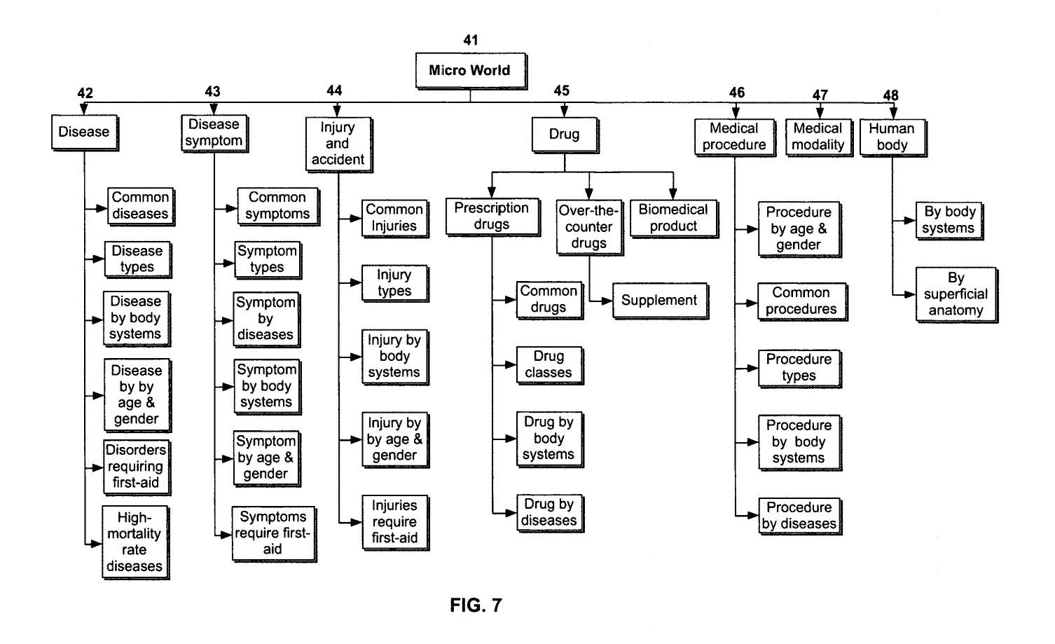

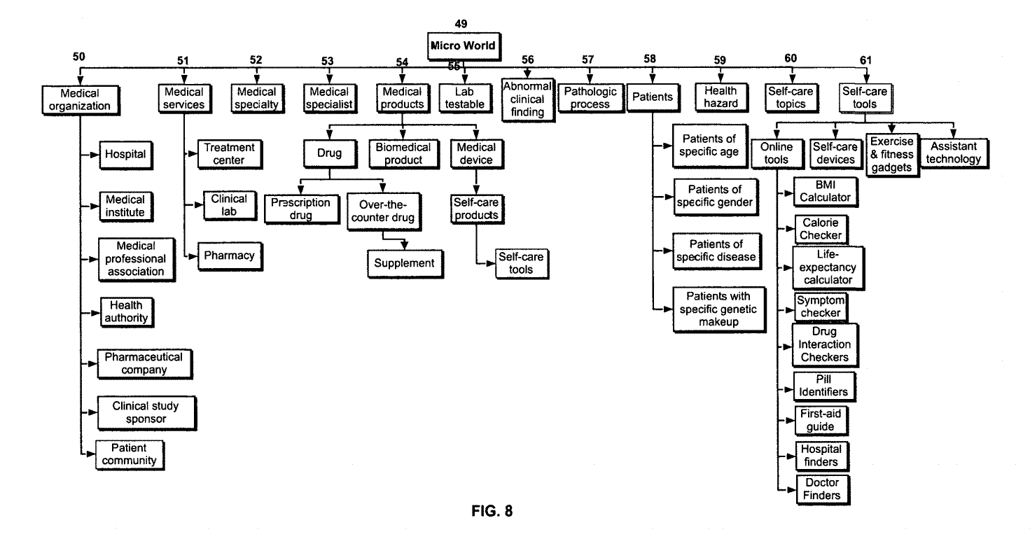

FIGS. 7-8 shows a structured representation of the micro world. The micro world represents domain-specific entities or object classes, particularly entities that are important for understanding the domain-specific nature of user's interaction. The illustrative medical micro world comprises various object classes relevant to medicine and health, such as disease, symptom, injury, drug, medical procedure, medical modality, human anatomy, online tools, and many other medical-related objects or topics. Some illustrative examples of object classes represented in medical micro world are shown below:
Disease
   Common diseases
   Disease types
   Diseases by body systems
   Diseases by age & gender
   Diseases requiring first-aid
   High-mortality rate diseases
Disease symptom
   Common symptoms
   Symptom types
   Symptoms by body systems
   Symptoms by age and gender
   Symptoms by diseases
   Symptoms requiring first-aid
Injury and accident
   Common Injuries
   Injury types
   Injuries by body systems
   Injuries by age & gender
   Injuries requiring first-aid
Drug
   Prescription drugs
      Common drugs
      Drug classes
      Drugs by body systems
      Drugs by diseases
   Over-the-counter drugs
      Supplements
   Biomedical products
Medical procedure
   Common procedures
   Procedure types
   Procedures by body systems
   Procedures by age & gender
   Procedures by diseases
Medical modality
Human body
   By body systems
   By superficial anatomy
Medical specialty
Medical specialist
Medical organization
   Health authorities
   Medical professional associations
   Medical institutes
   Pharmaceutical companies
   Clinical study sponsors
   Hospitals
   Patient communities
Lab testable
Abnormal clinical finding
Pathologic process
Patient
   Patients of specific age
   Patients of specific gender
   Patients with a specific disease
   Patients with specific genetic makeup
Health hazard
Medical service
   Treatment centers
   Clinical labs
   Pharmacies
Medical product
   Drug
      Prescription drugs
      Over-the-counter drugs
         Supplements
   Biomedical products
   Medical devices
      Self-care products
         Self-care tools
Self-care tool
   Online tools
      BMI calculators
      Calorie checkers
      Symptom checkers
      Drug interaction checkers
      Pill identifiers
      First-aid guide
      Hospital finders
      Doctor finders
      Life-expectancy calculators
   Self-care devices
   Exercise & fitness gadgets
   Assistant technology
Self-care topic

### The Properties of Object Classes

In the illustrative micro world of medicine, in addition to the object classes, some properties are also specified when possible. For instance,

A DISEASE can be gender related

A DISEASE can be age related

A DISEASE can be body part related

A DISEASE can be body function related

### The Quality of the World Models

The quality of the world models is concerned with the following aspects:

A sufficient model of the world: It is recommended to build a sufficient model of the world to include everything important in order for the semantic system to work at its best. The model of the macro world should include thing that matters, especially things with which users will mostly likely interact with in a given task domain. For instance, research has shown that diet and exercises are important part of health self-care, so the macro world model needs to have the representations of different diet plans and exercises when defining the micro world in medicine, even if these diet plans and exercises may not form a hierarchical structure. As for the micro world, it is useful to specify all entities and object classes in the domain so that the system has the built-in capacity to identify all topics in the text. The illustrative example of the micro world is concerned with medicine and it includes almost all diseases, drugs, medical procedures, etc.

Flexible structure: It is preferable that all entities are well organized, using a hierarchical/tree structure such as an ontology, a classification, or other structured form so that the relationship between entities can be easily identified. However, the system permits the existence of a flat list of things that share certain properties. For instance, the macro world model contains flat lists of different diet plans and different exercises. The domain- specific world model contains flat lists of common diseases, common drugs, common medical procedures, popular health topics etc. The world model even allows the existence of a flat list that contains different object classes, as long as they share some properties, such as risk factors of all kinds. This is important because the world models need to be flexible enough to represent all things that matter, even if they don't fit a hierarchical structure.

Multiple classifications: The entities in each object class can be cross referenced and have multi-classifications, so a given entity can appear in different object classes for different purposes. For instance, many medical entities are classified by body systems, by age & gender, or by body functions, as many classifications as needed for different purposes.

### Cognitive Frames

A cognitive frame is the specification of users' interaction with the world, including the important things that users should do or know in such interaction. The specification of things that users should do includes tasks and subtasks that users normally perform in a given situation, as well as actions, procedures, processes (including cognitive processes) involved in performing each task specified. The specification of things that users should know includes concepts, principles, theories, and methods that users should understand in order to perform a task successfully. The cognitive frames are specified in as much detail as necessary, depending on the goal of the analysis and nature of the domain. However, it is preferable that a cognitive frame is specified adequately to allow the identification of the key concepts, procedures, tasks, and processes related to a topic, but also the aspects of concepts, procedures, tasks, or processes necessary for people to understand a topic or perform a task. This is a key difference between the cognitive frame and the ontology (or classification) described in the world model previously.

Similar to the structure in the world model, it is preferable that all cognitive frames are well organized, using a hierarchical/tree structure so that the relationship and processes in the frames are clearly indicated. However, the system also permits the use of flat lists for indicating things important for people to know or do in their interaction with the world.

Two types of cognitive frames are specified in the illustrative embodiment: Generic and domain-specific cognitive frames.

### Generic Cognitive Frame

Generic cognitive frames are specified for characterizing people's general interaction with the world, including tasks, activities, and cognitive processes involved in such interaction. Based on the classification of human activities from a cognitive perspective, the following generic cognitive frames are specified: sense making, performance, planning, decision making, risk management, diagnostic problem solving, reviews & rating, design & creation, exams & tests, consulting experts, searching for and obtaining things, communicating & sharing. Each of these frames are specified in details to address the concepts, procedures, processes, challenges, and information needs of users in particular situations. These generic cognitive frames can be applied to most object classes represented in the world model. For instance, the generic cognitive frames can be applied to chemotherapy, which results in: making sense of chemotherapy, performing chemotherapy, making decision about chemotherapy, planning chemotherapy, and so on. Although the generic cognitive frames are applicable to most knowledge domains, they may not be very relevant to a particular type of users in a given context. For instance, the design and test of chemotherapy may not be very relevant to a patient who is seeking self-care information when undergoing chemotherapy. Therefore, it is necessary to make assumptions about who the target users are and what are the possible situations, tasks, processes, and information needs of the users in a given task domain. That's the main reason for specifying domain-specific cognitive frames.

### Domain-Specific Cognitive Frames

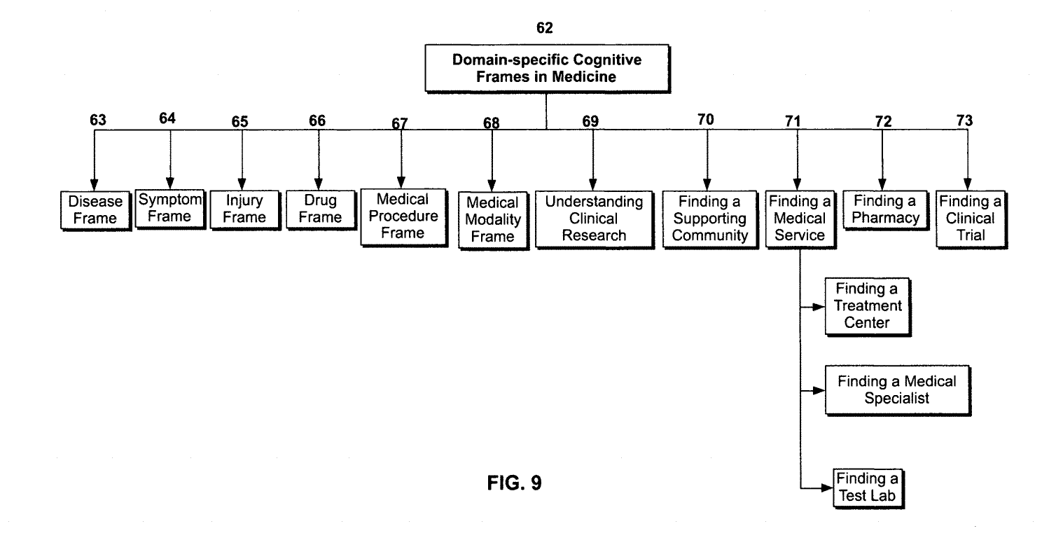

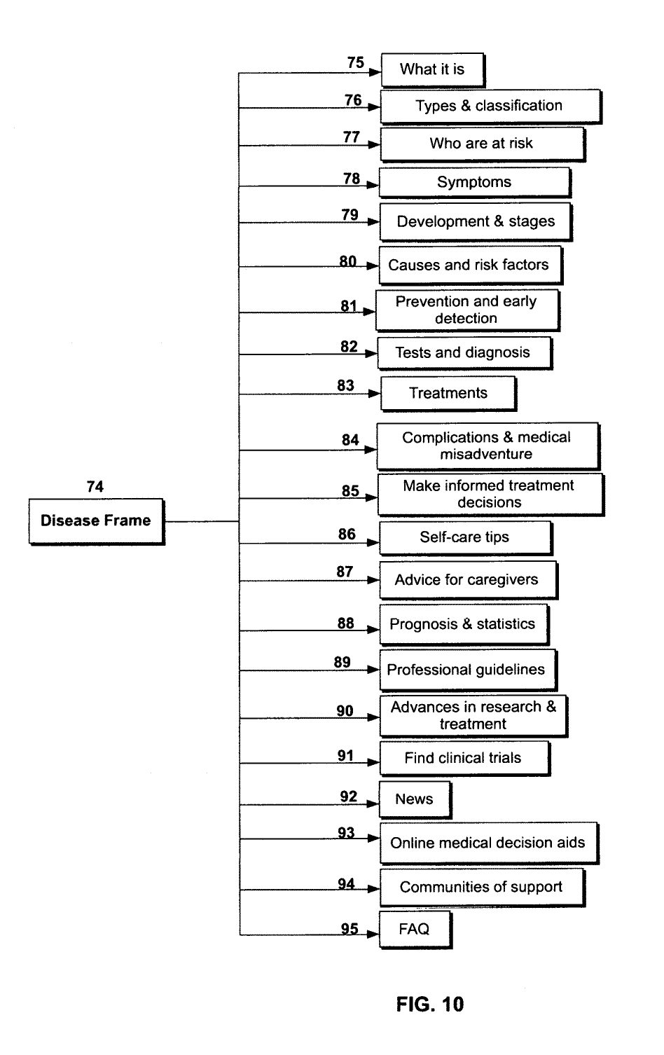

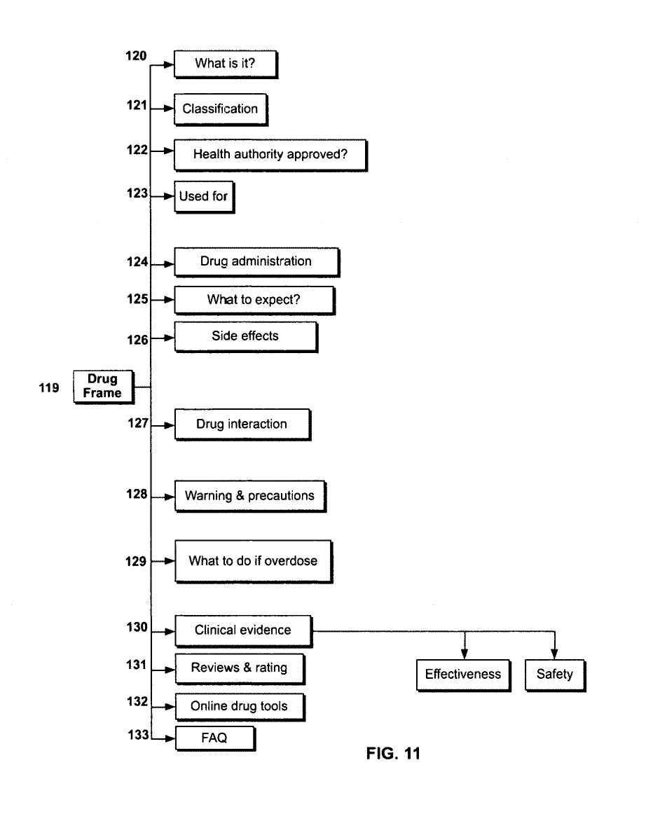

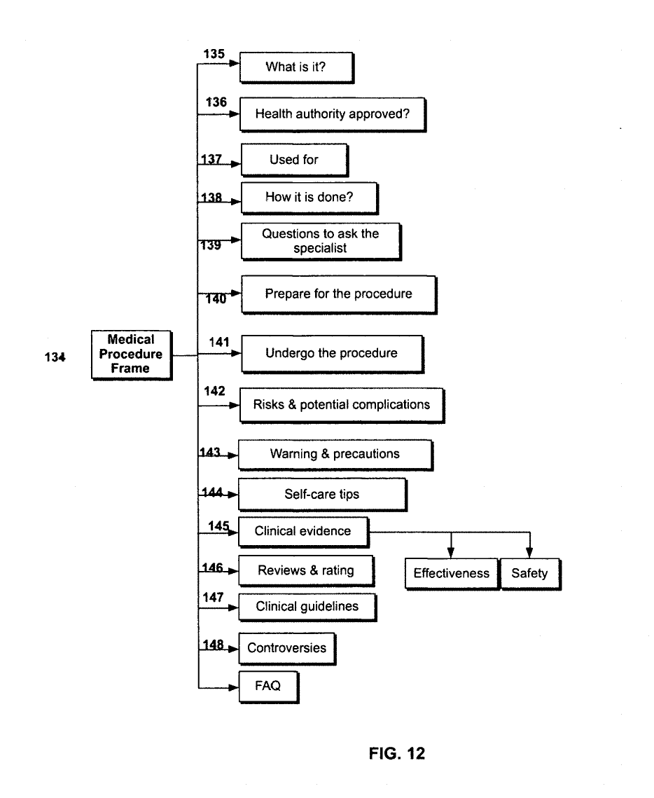

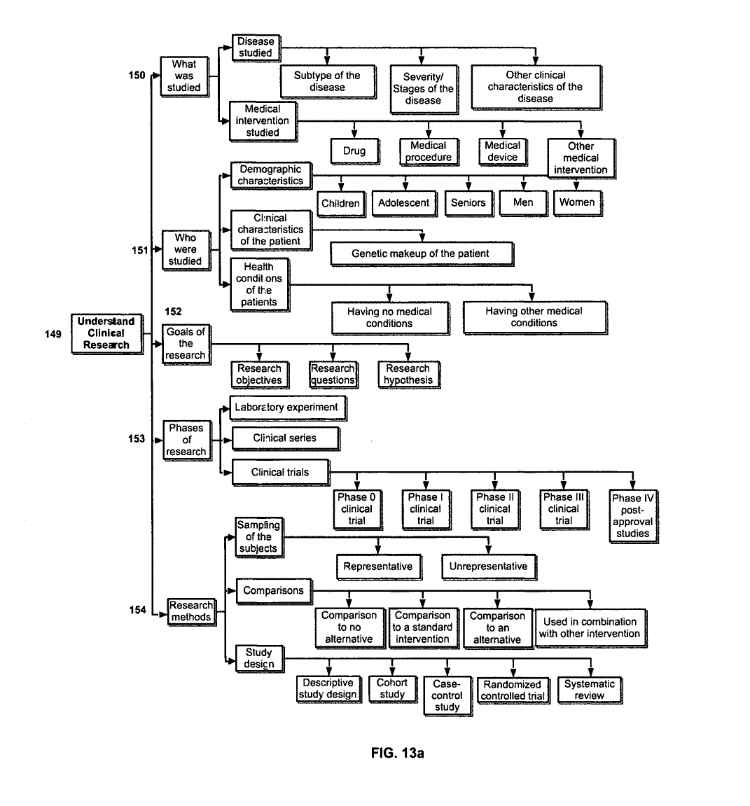

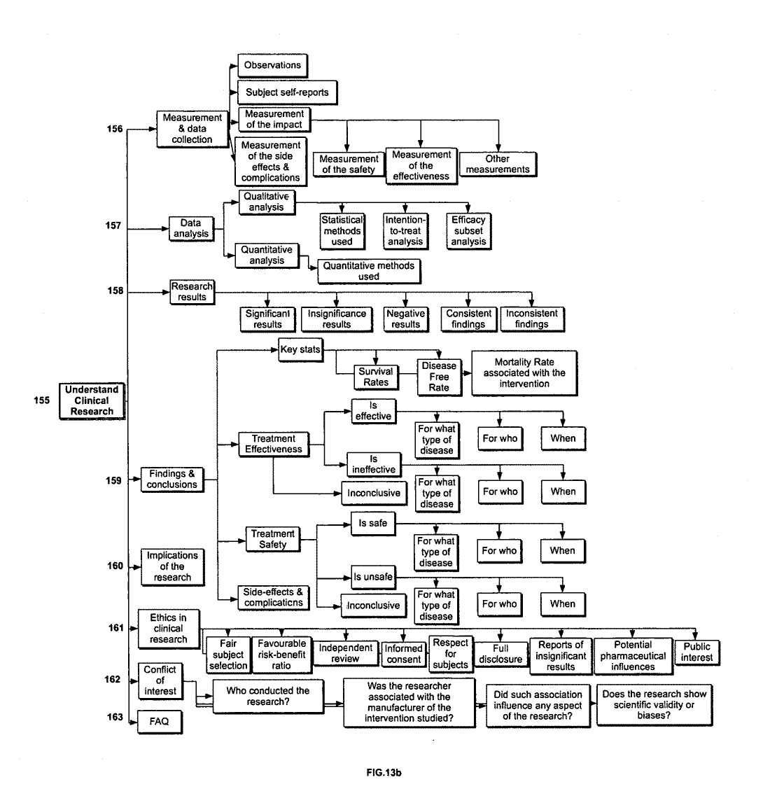

In the illustrative example, a wide range of domain-specific frames are specified to characterize users' interaction with both the medical micro world and the generic macro world concerning health-related tasks, from a consumer and patient perspective. Separate domain-specific cognitive frames are specified for all object classes defined in the medical micro world. FIG. 9 is an illustrative embodiment of the domain-specific cognitive frames in medicine. They include frames for diseases (FIG. 10), symptoms, injuries, drugs (FIG. 11), medical procedures (FIG. 12), medical modalities, finding a supporting community, finding a medical service, finding a pharmacy, finding a clinical trial, self-care, and other health-related topics. To highlight the importance of evidence-based medicine, a domain-specific cognitive frame for clinical research is specified (FIGS. 13a-b). These different medical frames are specified using the general cognitive frames as building blocks. These medical frames include the specification of attributes, relations, tasks, processes, actions, and interactions with particular medical objects. Most of the cognitive frames for medical micro world are very detailed, covering not only concepts that are important for understanding a given topic, but also tasks and processes related. The example below shows mostly the top two levels of the disease frame (FIG. 10):

### Disease Frame

What it is
   Definition
   Alternative names
   Abbreviation
   Clinical characteristics
   Examples
   Facts & statistics
   Misconceptions
Types & classification
   Common classification
   Pathological classification
   Histologic classification
   Classification by body system
Who are at risk
   Patient history
   Family history
   Age groups
   Gender groups
   High-risk ethnicity
   Regional scope
   Patients with certain diseases
Symptoms
   Typical signs
   Signs specific to gender/age groups
   Atypical signs
   Absent signs
Development & stages
   Incubation time
   Contagious period
   Duration of disease
   Origin
   Evolution
   Severity/Stages
Causes & risk factors
   Causes
   Risk factors
   General risk factors
      Genetic factors
      Effects of unhealthy lifestyles
      Environmental factors
      Other diseases
Prevention & early detection
   Prevention
   Screening & early diagnosis
Tests & diagnosis
   Physical examination
   Clinical hypothesis
   Clinical tests
   Making diagnosis
      Making differential diagnosis
      Validating the diagnosis
Treatments
   Treatment options
   Drug therapy
   Medical procedures
   Alternative medicine
   Other treatment modalities
Potential complications & medical misadventures
   Complications of the disease
   Complications due to the intervention
   Common medical errors
   How to prevent medical misadventure
Making informed treatment decisions
   Threshold for treatment
   Assessing treatment options
   The pros and cons of treatment options
      Treatment effectiveness
      Treatment safety
   Treatment financial costs
   Adverse effects
   Opportunity cost
   Evidence based treatment decisions
      Treatment effectiveness
         What is effective
         For what subtype of disease it is effective
         For whom it is effective
         When it is effective
      Treatment safety
         For what it safe
         For whom it is safe
         When it is safe
Shared medical decision making
Personalized treatment: things to consider
   Specific disease subtype
   Age
   Gender
   Genetic makeup
   General health
   Other medical condition
   Personal preferences
Getting a second opinion
Self-care tips
   If you are at risk
      Recommended vaccinations
      Recommended screening tests
   If you get an abnormal test result
      Interpreting the test result
      What is the normal range for your age and gender?
      What does abnormal test result mean?
      Self-monitoring your condition
      Follow-up tests
   If you are diagnosed with a disease
      Understanding your treatment options
      Making informed treatment decisions
      Getting a second opinion
   If you suffer from a disease
      Following your treatment plan
      Pain & symptom relief
      Recommended dietary plans
      Recommended physical activities
      Lifestyle modification
      Rehabilitation
      Ways to live a fulfilling life
   If you are undergoing a treatment
      Things to do
         Before the procedure
         During the procedure
         After the procedure
   In case of emergency
Advice for caregivers
Statistics & prognosis
   Incidence rates
   Survival rates
   Mortality rates
   Life expectancy
   Recovery rates
   Recurrence
   Prognostic factors
Professional guidelines
   Standard clinical guidelines
   New guidelines
Advances in research & treatment
   New prevention method
   New screening method
   New diagnostic tests
   New treatments
Finding a clinical trial
News
   Advances in research & treatment
   Disease outbreak
   Drug alerts and recalls
Online medical decision aids
Communities of support
FAQ

It is worth noting that a great importance is given to tasks and task-relevant information in order to identify the knowledge, skills, and processes involved in performing various tasks that people often face in a given situation. In the illustrative embodiment of the disease frame, a great emphasis is placed on the functional use of medical knowledge in order to help user understand their health conditions, make better decisions, and take better care of themselves. These frames also address key issues in effective patient engagement such as disease prevention, early detection, treatment decision making, evidence based medicine, personalized medicine, and self-care (see FIGS. 10a-d). As for the medical procedures, beside the aspects related to the general understanding of the procedure (e.g., what it is, what it is used for, how it is done), the procedures frame focuses on the tasks that the users often face and for which they need self-care guidance, such as guidance for before, during, and after a medical procedure, as well as information about potential complications and tips about how to prevent them.

Similarly, in the illustrative embodiment of the cognitive frame specified for understanding clinical research (FIGS. 13a-b), a great importance is given to issues related to the effectiveness and safety of medical interventions, and the conditions in which an intervention is effective and safe (e.g., for what disease subtype, for who, and when an intervention is effective or safe). Such information is important for helping users develop good understanding, judgment, and the ability to make wiser decisions concerning particular medical interventions, so cognitive frames need to be specified to the extent that they can characterize the information that is important to users.

### The Quality of Cognitive Frames

The quality of cognitive frames is concerned with the following aspects: Task relevance: A great importance should be given to tasks and task-relevant information when specifying a cognitive frame, in order to identify information that can help users understand, perform, and make good decisions concerning these tasks.

Sufficiency: A cognitive frame should be sufficient enough to characterize the important entities, attributes, actions, interactions, and relations important in a given context, covering both conceptual or procedural aspects of knowledge.

Structure: A cognitive frame should be as complete as possible, and as structured as possible. It is recommended to use a hierarchical or tree structure to organize the sub- cognitive frames in order to better support the semantic analysis of the text. However, the system also permits the use of a flat list for indicating things important for people to know or do in their interaction with the world.

Coherence and logic: Coherence and logic should be reflected in structure of cognitive frames, if there is any. All sub-frames should inherit the same attributes from the higher- level frame in the tree structure. When procedures and actions are involved, the specifications should include the sequences or processes.

Reusable: A frame or sub-frame can be reused as the building block for other cognitive frame or sub-frame, as long as it fits logically in the place where it is reused.

### The Primary Functions of Cognitive Frames

A great challenge in semantic search is to understand the intent of the users and contextual meaning of the search terms. The cognitive frames disclosed provide meaningful contexts for understanding user's intentions, tasks, and information needs. By specifying a meaningful and adequate model of actions, interactions, and the processes involved, a cognitive frame can serve three important functions: (a) a characterization of the conceptual and task-relevant information on a topic through semantic analysis of digital text, (b) a specification of things that users should know and do on a given topic, serving as a model of expertise for directing user's search and learning and, (c) an identification of the task, activities, processes, and information needs of users within a coherent framework, providing a meaningful context to understand user's goal and evaluate the relevance of information. When being used with semantic rules described below, the cognitive frames disclosed serve as schemata for analyzing, understanding, ranking, indexing, storing, retrieving, and extracting computer readable text.

### Semantic Rules

Semantic rules are specified to characterize the linguistic descriptions of entities, attributes, relations, processes, actions, and interactions in relation to a specific cognitive frame. Each node of the cognitive frame is associated with a variety of semantic rules in order to analyze the text. The semantic rules are used to analyze the linguistic elements in the text of digital content, as well as users' input in an interactive information system. In the illustrative embodiment, a large number of semantic rules are specified to identify the meaningful aspects of diseases, drugs, medical procedures, and many other health-related objects. These meaningful aspects of an entity include attributes (e.g., a disease is contagious), relations (e.g., a drug is effective for treating a disease), actions (e.g., people need to practice healthy diet and regular exercises to reduce the risk of diabetes), and interactions (e.g., one drug interacts with another drug) etc.

Semantic rules can be classified into two types: Strict semantic rules and loose semantic rules. Strict semantic rules are strict linguistic patterns whereas loose semantic rules are a set of keywords where intermediary words are allowed but not specified and/or where the actual order of words is not always specified. Ultimately, a loose semantic rules can consist of a single lexical element to be found anywhere in the text.

For instance, the disease frame comprises a sub-frame named DRUG THERAPY (DISEASE:TREATMENTS:DRUG-THERAPY), two types of semantic rules are associated with this sub-frame:

Strict semantic rules:
A DRUG treats a DISEASE . . .
A DISEASE can be treated with a DRUG . . .
A DRUG can be used to treat a DISEASE . . .
A DRUG can be used for patient with DISEASE . . .
SPECIALISTS use DRUG as the first-line treatment for DISEASE patients . . .

Those strict rules are precise but they may be limited in their coverage. As language is complex and there are a great variety of ways to express the same meaning, some “loose rules” are also developed to identify the meaning of more complex sentences.

Loose semantic rules:
A DRUG treats*DISEASE
DISEASE can be treated*DRUG
DRUG can be used to treat*DISEASE
DRUG can be used for*DISEASE
DRUG*treatment*DISEASE
DRUG*DISEASE

As a loose semantic rule can be a set of keywords in any order, or even a single lexical element, loose semantic rules can have wide coverage but lack accuracy, and sometimes they can generate noise and even errors. One needs to strike a delicate balance between the strict and loose semantic rules and adjust the two types of rules to achieve desired accuracy and coverage for a particular purpose of semantic analysis.

### 2. The Mechanisms and Processes

The world model and cognitive frames disclosed have been successfully implemented in the illustrative embodiment for ranking medical web pages. Generally speaking, the illustrative embodiment applies a cognitive-based semantic process to analyze, understand, rank, select, store, display, and extract the meaningful text of digital content.

### Mechanism and Processes for Analyzing the Deep Content of Text

One of the main problems that leads to superficial lexical retrieval of text by existing search engines is due to the fact that these search engines lack adequate understanding of what constitutes the meaningful content on a web page. The disclosed system applies semantic rules that are associated with a world model and cognitive frames to the analysis of sentences on a page, making it possible to identify its meaningful content. Using the example presented earlier, the following sentences all match at least one linguistic pattern in the semantic rule associated with a cognitive frame:
STATINS treat HIGH CHOLESTEROL
RULE: DRUG treat DISEASE
HIGH CHOLESTEROL can be treated with STATINS
RULE: DISEASE can be treated with DRUG
STATINS are used to treat HIGH-CHOLESTEROL
RULE: DRUG can be used to treat DISEASE
STATINS can be used for patient with HIGH-CHOLESTEROL
RULE: DRUG can be used for patient with DISEASE.
CARDIOLOGISTS have been using STATINS as the first-line treatment for HIGH CHOLESTEROL patients.
RULE: SPECIALISTS have been using DRUG as the first-line treatment for DISEASE patients . . .

In the illustrative example, all these semantic rules are associated with an object class DISEASE “HIGH-CHOLESTEROL”, a cognitive frame (DISEASE:TREATMENT- OPTIONS:DRUG-THERAPY), as well as semantic rules that specify an action and a functional relation (X_BE-USED-TO-TREAT_Y). So the system understands that “STATINS” are DRUG used to treat the DISEASE “HIGH-CHOLESTEROL”, or the DISEASE “HIGH-CHOLESTEROL” can be treated with DRUG “STATINS”. As all these sentences match a variety of semantic rules that specify (X_BE-USED-TO-TREAT_Y) in the cognitive frame (DISEASE:TREATMENT-OPTIONS:DURG-THERAPY), these sentences are characterized as “DRUG-THERAPY” used for treating HIGH-CHOLESTEROL”. The meaning of a sentence is established through such associations.

It is important to indicate that the above sentences also match the semantic rules associated with another object class DRUG “STATIN” and its cognitive frame (DRUG:USED-FOR:TREATING-A-DISEASE), as well as its semantic rules that specify the action and a functional relation (Y_TREATS_X). So the system understands that “STATIN” is a DRUG used for treating the DISEASE “HIGH-CHOLESTEROL”, or the DISEASE “HIGH-CHOLESTEROL” can be treated with DRUG “STATIN”. So the meanings of these sentences are established in two different object classes through such semantic analysis, which is very similar to human understanding of such entities, their functions, as well as the functional relationship between entities in different object classes. Such mechanisms and processes serve as the foundation for understanding text.

The method and process described can be used to analyze any forms of digital text (e.g., titles, sentences, paragraphs, and pages of web content, video description, image labels, emails, etc.), with reference to specific topics, cognitive frames and, and semantic rules.

### Mechanism and Processes for Ranking the Relevance of Digital Content

Besides applying semantic rules to the analysis of each sentence on a page, the system looks at each page as a whole in order to determine the nature of a page using multiple ranking algorithms and metrics. Both qualitative and quantitative methods are used to measure the relevance of pages, with the main goal being to identify what a page is about (identifying the topic or entity), and evaluate what aspects of the topic are covered (as indicated by the coverage of the corresponding cognitive frame). For instance, to evaluate the relevance of pages about “high cholesterol”, all pages are analyzed using the disease frame on high cholesterol. In the end, if a page covers more important issues represented by the disease frame (FIG. 10), then this page is deemed more relevant and it will be ranked higher than the pages that have less coverage. Thus, the measure of relevance in the disclosed method is based on the meaning of the text and its relevance to the goals and tasks of potential users. Such measure of relevance is more meaningful and fundamentally different from the measures that use the keyword and URL link frequency or other attributes. The ranking mechanism disclosed can be used to rank all computer readable text, including text attached to non-textual digital content (e.g., videos, images, graphs) to assist the understand of such non-textual digital content.

### Generating and Storing a Database Containing Meaningful Digital Content

The system generates a database of meaningful sentences and pages associated with all object classes (topics) specified in the micro world cognitive frames, and semantic rules through the semantic analysis mechanism described above. The system then indexes all sentences and pages by associating them with specific topics and cognitive frames and stores them in a database.

Mechanism and Process for Semantic Extraction

Semantic rules specified in the system allow the extraction of the relations between entities or object classes involved. For instance, the strict semantic rules listed above allow confident extraction of the following relation:
STATINS treat HIGH CHOLESTEROL
CARDIOLOGISTS treat HIGH CHOLESTEROL with STATINS
CARDIOLOGISTS treat HIGH CHOLESTEROL patients with STATINS

Loose semantic rules can also be used to extract information, they can extend the coverage but they can also generate noise. The extraction should rely on the strict semantic rules to allow confident extraction.

### Mechanism and Processes for Matching User Search Query to the Text Found in the Database

Part of the difficulty in providing relevant information to users is due to the fact that existing search engines lack adequate understanding about the goals and tasks of users concerning specific search queries. To improve the search technology, the system disclosed generates a database of sentences and pages associated with specific topics (object classes), cognitive frames, and semantic rules through semantic analysis of the text. To match such content to user's search query and provide search results that user needs, it is important to understand the goal, tasks, and challenges that the target users may face when making a search query. FIG. 5a illustrates an example of such analysis:

A user types “HIGH CHOLESTEROL” in the search box.

The system assumes that the goal or intention of the user is not primarily to find popular pages linked to the word “high cholesterol” (the page popularity is the most common measure of relevance used by existing search engines). Instead, the system assumes that the user is looking for meaningful information that helps him:
Make sense of his situation;
Know what caused it;
Assess whether it's serious;
Learn whether he can do something to control it;
Decide whether he should see a doctor;
Make other decisions.
   Also, the system assumes that user may face the following situation and challenges:
Have experienced symptoms;
Lack sufficient knowledge to deal with it;
Not be aware of the different issues he needs to consider about his condition;
Lack terminology or vocabulary to address these different issues;
Lack strategy to conduct effective Internet searches;
Be overwhelmed and frustrated, be left with insufficient and fragmented understanding, etc.

It is clear that the user is searching information that can support him in dealing with tasks within the context specified by his search query “high cholesterol”. As the system has already applied all semantic rules associated with the disease frame “HIGH CHOLESTEROL” to the analysis of all text and stored the analyzed text in the database, it has all the information and mechanism to match what the user is searching with the text stored in the database.

In response to the user's query “HIGH CHOLESTEROL”, the system finds the information on the topic “HIGH CHOLESTEROL” from its database, then provides user with a set of information associated with the cognitive frame for HIGH CHOLESTEROL. In the illustrative example, the system provides the following information related to the “HIGH CHOLESTEROL” frame to help the user better understand his condition, make informed decisions, and engage in effective self-care.
High Cholesterol
   What it is?
      Definition
      Clinic characteristics
   Cause and risk factors
   Development & stage
   Self-care tips
      Diet
      Exercises
      Other lifestyle modifications
      When to see a doctor?
   Tests and diagnosis
   Treatment options
      Drugs
      Other treatment options
      Alternative medicine
   Treatment decisions
      Threshold for treatment
      Pros & cons of a treatment
      How to choose a treatment?
   Professional guideline
   Clinic evidence
      What is effective
      When it is effective
      To whom it is effective
   Potential complications
   FAQ

As illustrated, the disclosed system successfully matches a user's search query with a set of information that corresponds to the goals and tasks of the user. This match is based on the analysis of users' goals, tasks, and challenges that they may face using the information provided by the search queries. Such mechanism and framework provides users with not only the information they need, but also a navigation guide for them to explore. In addition, the system can display more details of the cognitive frames and configure the cognitive frames in different ways to meet specific needs of its intended users.

### Mechanism and Processes for Constructing Guided Exploratory Interfaces

In the illustrative embodiment, a guided exploratory interface is built for providing a comprehensive overview of the different aspects of medical topics useful to users, and for guiding users in their information search. A guided exploratory interface comprises one or more of the follow components:

Domain-specific cognitive frame: A domain-specific cognitive frame is computed using web pages found on the topic. The frame is displayed to users to serve two functions: (a) as the coherent and concise knowledge representation of a topic to be explored. As a great focus can be placed on the functional use of knowledge, the information presented through cognitive frames can facilitate the development of users' understanding, problem solving, self-care strategy, and ability for making informed decision for a given situation and, (b) as the navigation map for guiding users to explore different aspects of the knowledge and processes, enabling users to decide what to explore, based on their situation, information needs and preferences.

Search results: The system ranks the relevance of the pages to the search query, using multiple page ranking algorithms and metrics. Search result pages are assembled from different sources, page titles and short summaries are displayed in the order of their relevance to the topic and its cognitive frame; In addition, users can click the icon of the source/website to see more search results from a given source or website.

Narrower search: The system can extract the meaningful relations between the entity for which the user is searching and entities in different object classes, then display such relations to users. This enables users to explore the specific relations between the current topic and related topics (e.g., relations between a disease and a diet, a disease and a drug, a disease and a medical procedure), all within the context of its cognitive frame.

Related searches: The system can also display related entities in the same class. For instance, entities that share the same property and cognitive frame.

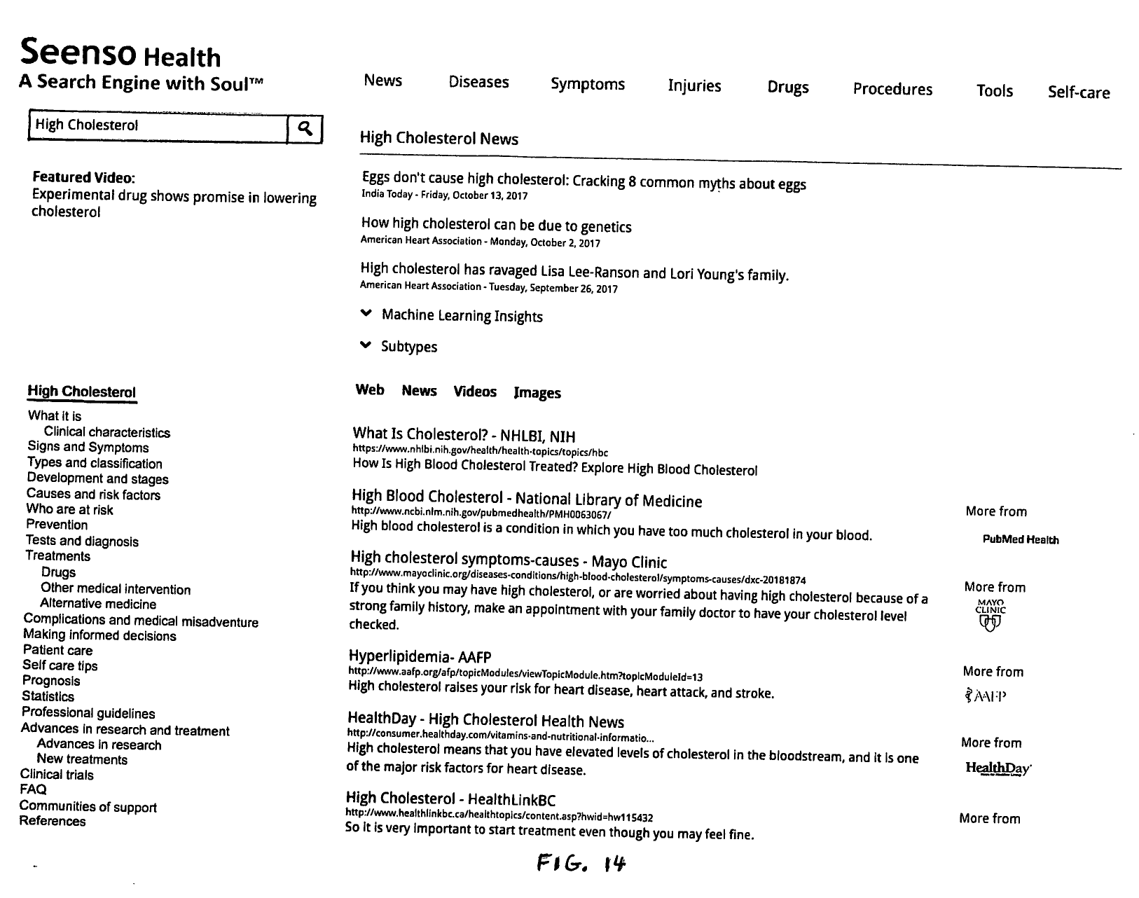

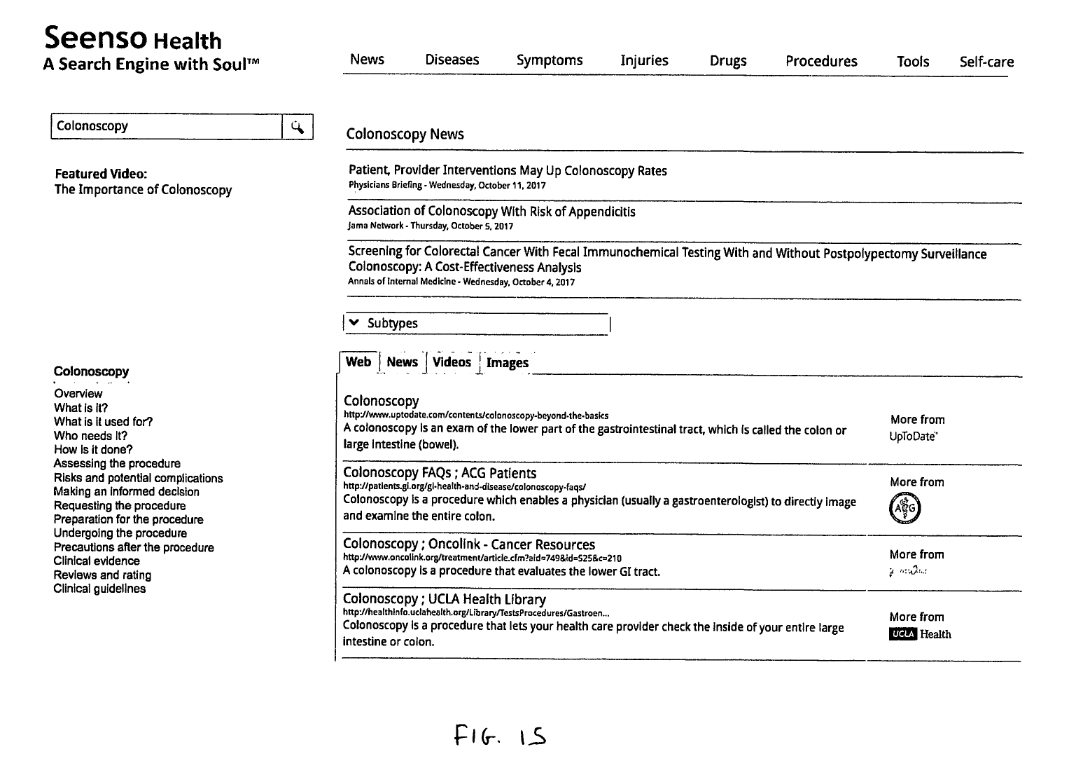

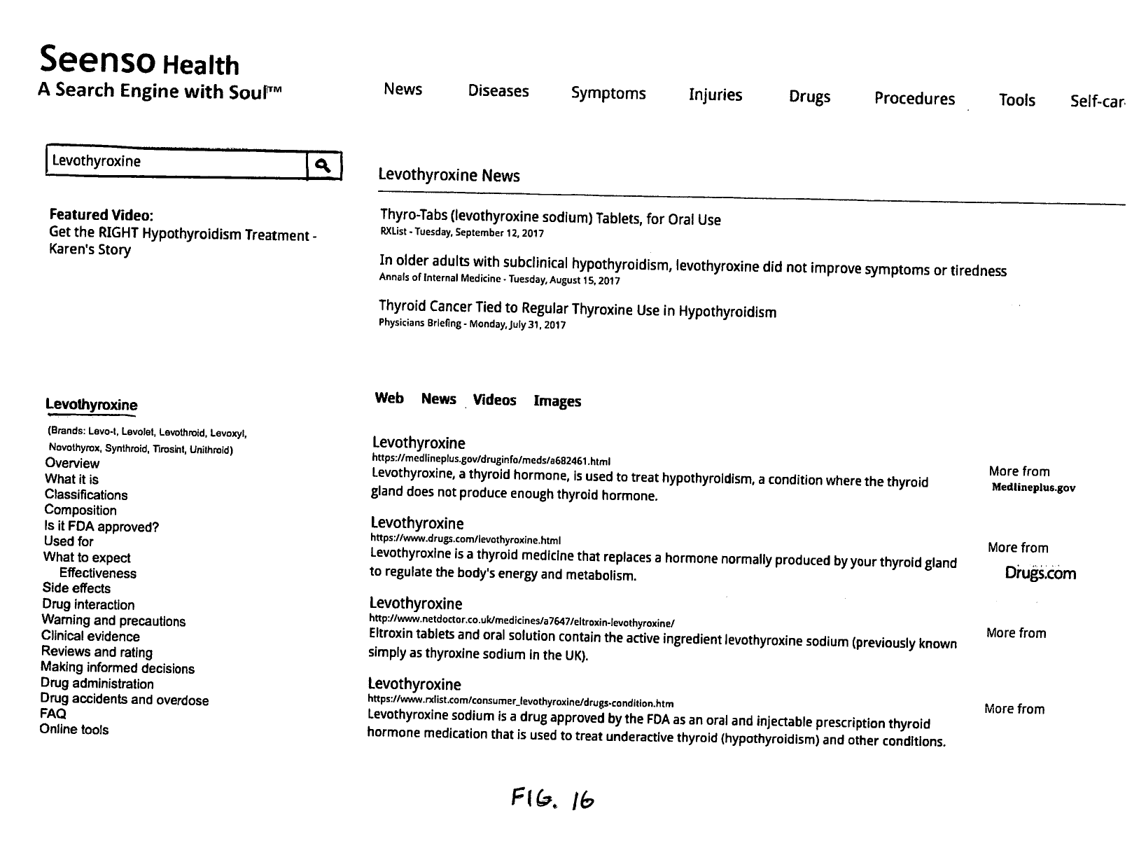

FIGS. 14, 15, and 16 are screenshots showing illustrative examples of guided-exploratory interfaces designed for disease, medical procedure, and drug, respectively.

In conclusion, the application of semantic rules that are associated with a world model and a cognitive frame to text analysis allows the identification of conceptual and task relevant information from the page content, providing a meaningful measure of the page relevance. Such measure of relevance is fundamentally different from the approaches that use keywords frequency and URL popularity as the primary measure of page relevance. The disclosed methods to automated text analysis and ranking in search engine technology are unique and much needed in the field. Through the combination of cognitive and semantic approach in text analysis, and a guided exploratory interface design, the system can make the search of information on the Internet more relevant, useful, and efficient.

The methods, system, apparatus disclosed in the patent represent a technological advancement in search engine technology. They are especially useful for improving the search of unstructured text, and on subjects that require higher level of accuracy and relevance. The disclosed methods and system have the potential to change the way that people search for information, either on the Internet or with computer readable files on the local machines, making search easier and better. The disclosed methods, system, apparatus are unique, innovative, and useful, and they have implications for related fields such as text mining, deep machine learning, and the development of artificial intelligence.

What is claimed is:

1. A computer-implemented method for analyzing digital text comprising:
A world model W where said world model specifies at least one class of entity C where said class comprises at least one entity E to be found in input texts.
A set of cognitive frames F containing at least one cognitive frame Fi where said cognitive frame is a specification of one or more meaningful aspects of an entity Ei or a class of entities Ci in the world model W.
A set of semantic rules R containing at least one semantic rule Ri where said semantic rule associates a linguistic pattern Pi to a cognitive frame Fi.
A process to computationally apply the linguistic pattern Pi of a semantic rule Ri to a segment of text Ti in order to generate a semantic representation which associates the text segment Ti with the cognitive frame Fi associated with Ri.

2. The method of claim 1 further comprising a step for generating a database containing the semantic representations.

3. The method of claim 1 further comprising a process for ranking texts based on comparison of features of the semantic representations of different texts.

4. The method of claim 1 further comprising a process for determining the nature or topic of a text using metrics based on the semantic representations of the text.

5. The method of claim 1 further comprising a process for understanding a text using its semantic representation.

6. The method of claim 1 further comprising a process for indexing texts based on features of their semantic representations.

7. The method of claim 1 further comprising a process for storing texts based on features of their semantic representations.

8. The method of claim 1 further comprising a process for retrieving texts based on features of their semantic representations.

9. The method of claim 1 further comprising a process for extracting information from text based on features of their semantic representations.

10. A data processing apparatus/device/system comprising means for carrying out the method of claim 1.

11. A computer program comprising instructions which, when the program is executed by a computer, cause the computer to carry out the method of claim 1.

12. A computer-readable medium comprising instructions which, when executed by a computer, cause the computer to carry out the method of claim 1.

13. A computer-implemented method for matching a user search query to text stored in a database comprising:
Receiving a query from a user.
Retrieving one or more text that matches the user search based on the semantic representation generated from the text(s) using method of claim 1.

14. The method of claim 13 where multiple ranking methods and metrics are used.

15. The method of claim 13 further comprising a process for identifying the topic or goal of the user search.

16. A computer-implemented method for constructing a user interface comprising:
Selecting a set of cognitive frames associated with texts analyzed with the method of claim 1.
Displaying this set to users.
